(19) United States
(12) Patent Application Publication
(10) Pub. No.: US 2005/0216428 A1
(43) Pub. Date: Sep. 29, 2005

(54) Distributed data management system

(75) Inventor: Yuichi Yagawa, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/806,998

(22) Filed: Mar. 24, 2004

(51) Int. Cl. G06F 7/00

(52) U.S. Cl. 707/1

(57) ABSTRACT

In a data storage system comprising a plurality of data centers, profile information for a data object such as a file is produced. Selection criteria associated with candidate data centers are compared with the profile information to determine whether or not the data object will be replicated to the candidate data center.

### BACKGROUND OF THE INVENTION

The present invention is generally related to data storage and in particular to replication of data among storage systems in a distributed storage system.

Enterprises and organizations require storage solutions that allow them to replicate data among different locations. Large enterprises usually obtain several data centers or data sites that are geographically dispersed throughout the country, or even all over the world, and want to replicate data among them. One reason for the need to replicate data among data centers or data sites is data protection. Administrators want to improve data availability by being able to obtain the same data from different locations, and to protect data against possible disaster.

Another reason for data replication is information sharing. Enterprises or organizations typically have a need to share information among data centers or data sites. Some examples of information sharing are as follows:

Content Distribution. Sales documents, educational materials, and any other company or enterprise related documents might be replicated and shared among branch offices.

Customers Relationship Management. An enterprise's customers information might be shared among different branch offices.

Medical information. Increasingly, there is a need to share medical records among medical institutes, since patients often go to different medical institutes, or switch medical plans.

A storage architecture concept known as Reliable Array of Independent Nodes (RAIN) can provide increased system redundancy by storing a file to more than two sites. This allows a file to be accessible if one site becomes unavailable.

Conventional approaches to file replication include replicating files to all sites. This approach is I/O intensive and presents a burden to the network, as a large percentage of the traffic is likely to be file replication activity. Another approach is a round-robin selection of target sites. Another technique is to consider the loading of each candidate target site and make a selection of one or more targets based on the loading conditions. Still another technique is simply a random selection of the target site(s).

### SUMMARY OF THE INVENTION

According to the present invention, file replication includes profiling a data object (e.g., a file) to obtain a content-based profile of the subject file. Each data center in the system is a candidate to be a target for replication of the subject file. Each data center is associated with selection criteria used to determine whether it will be a target for file replication. The determination is a function of the file profile of the subject file and the selection criteria. Thus, each data center can determine whether it will be a target for replication of a file from a source file server.

### BRIEF DESCRIPTION OF THE DRAWINGS

Aspects, advantages and novel features of the present invention will become apparent from the following description of the invention presented in conjunction with the accompanying drawings, wherein:

FIG. 1 is a high level block diagram showing an embodiment of a computer system according to the present invention;

FIG. 2 is a high level block diagram showing another embodiment of a computer system according to the present invention;

FIG. 3 is a generalized flow diagram highlighting process steps according to an embodiment of the present invention;

FIG. 4 is a generalized flow diagram highlighting steps performed for determining an interest metric;

FIG. 5 illustrates in tabular form interest information according to a specific implementation of an embodiment of the present invention;

FIG. 6 illustrates in tabular form file profile information according to a specific implementation of an embodiment of the present invention;

FIG. 7 is a high level block diagram showing another embodiment of a computer system according to the present invention;

FIG. 8 is a generalized flow diagram illustrating how updates to the interest information can be made;

FIG. 9 is a generalized flow diagram highlighting process steps according to the embodiment of the present invention shown in FIG. 7; and

FIG. 10 illustrates in tabular form file profile information according to a specific implementation of another embodiment of the present invention.

### DESCRIPTION OF THE SPECIFIC EMBODIMENTS

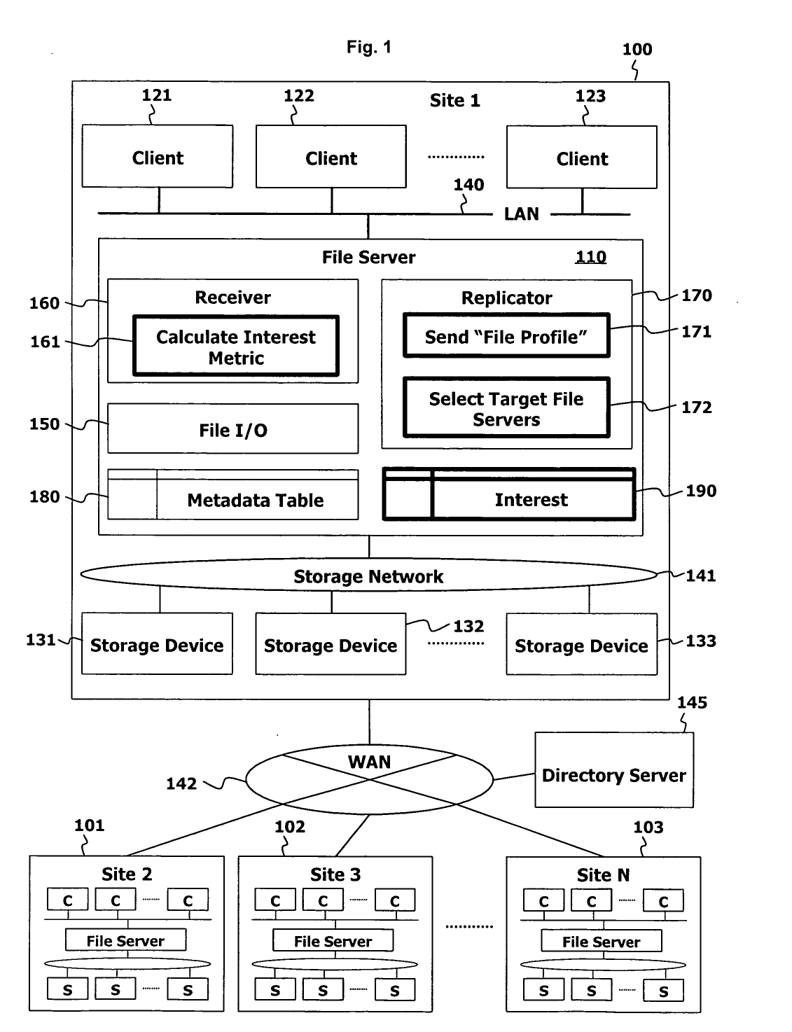

FIG. 1 shows an illustrative embodiment of a data system according to the present invention. A plurality of data centers 100, 101, 102, 103 are shown. The term “data center” used herein is intended generally to refer to any location that uses information. Typically, there is a file server and the users at the data center can be human users, or machine-based users. Other suitable terminology include data site, site, and so on. A data center can be a small business concern or an organizational department in a large enterprise. Data communication among the data centers is provided by a suitable communication network such as a WAN (wide area network) 142. A typical data center 100 comprises a file server component 110, although it is understood that large data centers may have two or more file servers. The file server is configured for communication with several clients 121, 122, 123 via a suitable communication network such as a LAN (local area network) 140. Typical communication protocols include TCP/IP.

The data center 100 also comprises a storage subsystem. The storage subsystem of the embodiment shown in FIG. 1 comprises a plurality of storage devices 131, 132, 133. A suitable storage network 141 provides access to the storage devices. For example, the storage network can be a SAN (storage area network) configuration based on a storage protocol such as FC (fibre channel), SCSI, iSCSI, and so on. A network attached storage (NAS) or an object-based storage configuration is also possible. It can be appreciated that any suitable storage subsystem architecture can be used; there is no requirement that the storage subsystem be a networked-based configuration. Other data centers 101, 102, 103 are similarly configured, with clients (C) and storage (S) arranged in a suitable configuration.

Clients 121, 122, 123 typically communicate requests to the file system 110 to write and to read files. A file I/O module 150 handles file write operations and stores data associated with the write operation the storage devices 131, 132, 133. Typically, metadata relating to the file is recorded and managed in a metadata table 180. The metadata information describes various file attributes, such as file name, file location, size, access control list, and so on. The file location typically includes a storage device id and the address(es) of the constituent data as stored in the device.

Though not shown, the various components are understood to comprise known hardware platforms and software components. For example, the servers and client systems comprise personal computers (PCs) and other appropriate computing machines. Storage subsystems can be implemented using known storage technology. Software components such as operating systems and storage management systems are known. The disclosed embodiments of the present invention can be implemented with suitable additional software and hardware components that will be apparent to one of ordinary skill in view of the following description.

The file server 110 includes a replicator module 170 which performs a replication operation that will be discussed in further detail below. A receiver module 160 performs the I/O to service a replication request. The file server of the particular embodiment shown in FIG. 1 includes information referred to as “interest information” 190. As will be discussed below, the replicator module of a file server designated as a source file server will communicate one or more files to one or more file servers designated as target file servers during a replication operation. The receiver module of each target file server will store the received file in its corresponding storage subsystem. As will be explained, determination of target sites is based on the interest information.

The replicator module 170 of the source file server can save the site IDs of the target file servers into its associated metadata table 180. Similarly, the receiver module 160 of a target file server can save the site ID of the source file server into its associated metadata table 180. The metadata information allows each file server to keep track of where its replicated files have been copied.

The replicator module 170 includes a send profile module 171. There is also a select target file server module 172. The receiver module 160 includes a calculate interest metric module 161. These modules will be discussed in further detail below.

A directory server 145 provides real addresses of the file servers; e.g., an internet address. The directory server functionality can be incorporated into the file server component 110.

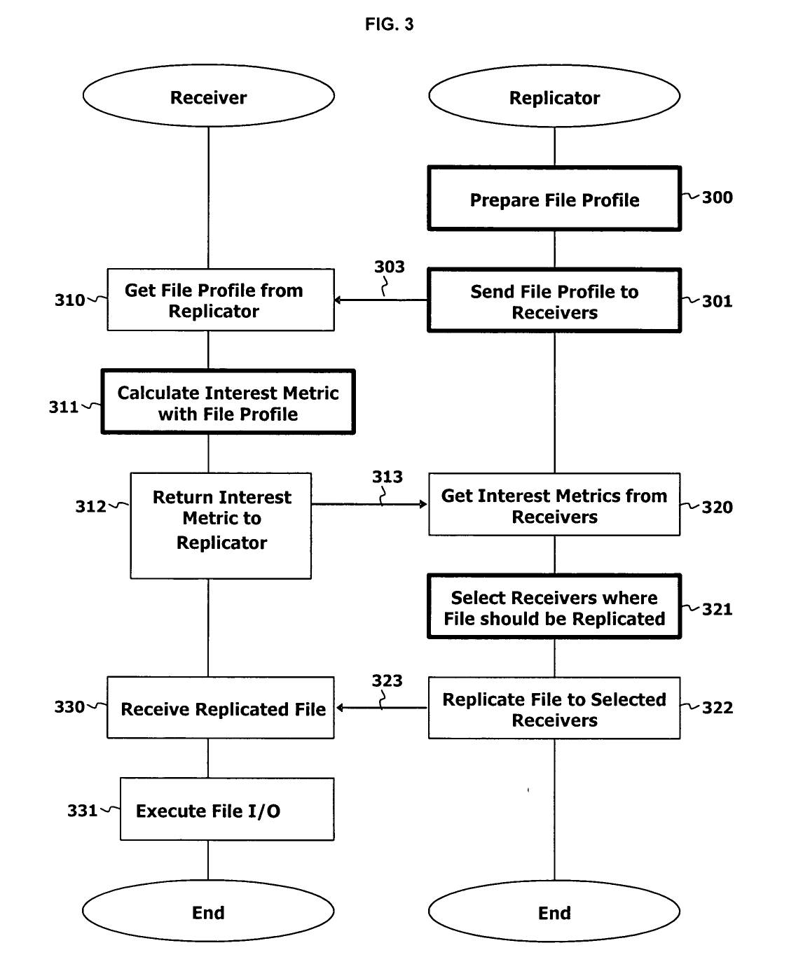

Refer now to FIG. 3 for a discussion of the operation of the data system according to the embodiment shown in FIG. 1. File replication according to the present invention includes a step 300 of creating a file profile of a file to be replicated (subject file). The replication operation can be initiated by a user request to create, edit, or otherwise perform a write operation on a file (the subject file). Alternatively, the replication operation can be performed in a periodic fashion where some or all the stored files are processed for replication at regular intervals, or on demand by a system administrator. It can be appreciated that file replication can be initiated by these and other triggering events. It is understood that the present invention is directed to how the replication process is performed, not by the triggering of the replication activity.

In accordance with the present invention, replication of a file is a selective activity. Moreover, the determination whether a file is replicated to file server is a function at least of the content of the subject file and of selection criteria specific to the data center that is the candidate target of the replication operation. In the illustrative embodiment of the present invention shown in FIG. 1, file profile information is used to represent or otherwise summarize the content a subject file (i.e., a file that is the subject of the file replication activity).

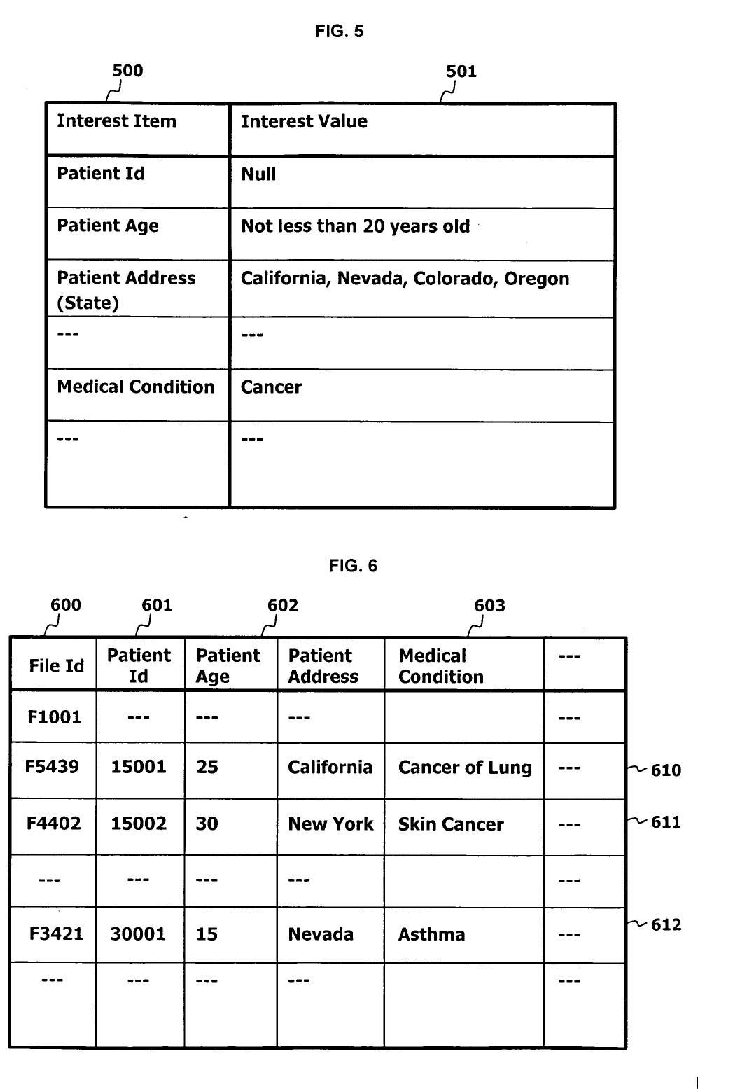

In accordance with the illustrated embodiment, the file profile contains information that is representative of the content of the file being profiled. For example, a file profile can be created for a file by performing a word count of certain key-words. A list of key-words from users can be compiled and maintained. A file profile can comprise excerpts from the file being profiled. The file profile can include the file type. The file can be analyzed and common words can be extracted to produce the file profile. It can be appreciated by one of ordinary skill that any appropriate content-based analytical or indexing technique can be used to create a file profile. Also, profiles created by users or created by profiling software can be used. It can be appreciated that conventional file attributes such as file size, file dates (creation, modification), and other non-content-based attributes would not be the only information in a file profile, though such information may be included along with content-based attributes. The information shown in FIGS. 5 and 6 used for purposes of explaining aspects of the present invention is a simple example of file profile information according to the present invention.

Continuing with FIG. 3, in a step 301, the replicator module 170 of the file server designated as the source file server (i.e., the file server that is performing the replication operation on a file) sends the file profile 303 to one or more file servers, referred to as candidate target file servers. In one implementation, the file profile is sent to each file server that is known to the source file server. This step might involve accessing the directory server 145 to obtain address information for the candidate file servers.

The receiver module 160 in each candidate file server receives the file profile in a step 310. Based on the file profile, a determination is made whether the subject file will be replicated at the data center. In accordance with the embodiment of the present invention shown in FIG. 1, this determination begins in a step 311 in the calculate interest module 161.

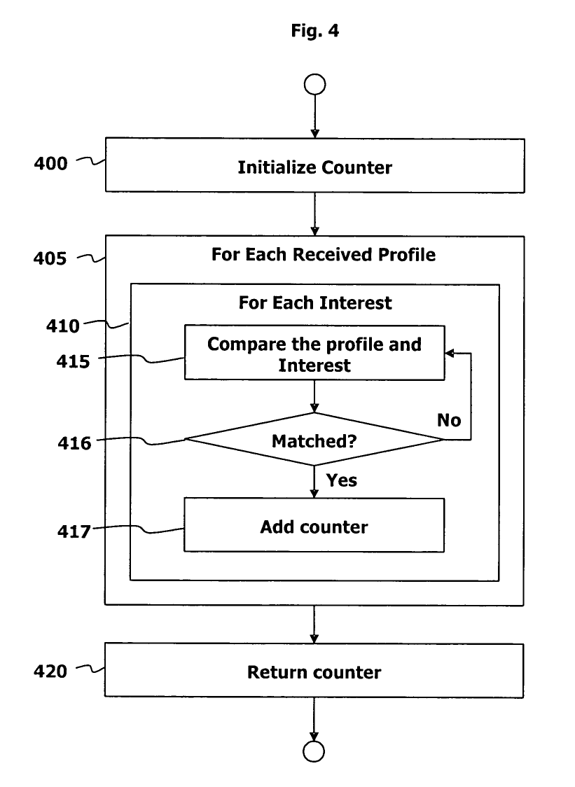

Refer now to FIGS. 4-6 for a discussion of the operation of the calculation interest module 161. FIG. 4 shows a calculation algorithm that is applied to the file profile and to the interest information 190 to compute an interest metric. FIG. 5 shows in tabular form an example of the interest information 190 illustrated in FIG. 1. FIG. 6 shows in tabular form an example of the file profile information illustrated in FIG. 1. The examples show information for medical records.

Referring to FIG. 5, the interest information 190 comprises an interest category 500 and specific “category values” 501 for the interest category. As shown in the figure, interest categories include information such as “patient ID,” “patient age,” “patient address,” “medical condition,” and so on. Interest category values can be a range of values or enumerated values. For example, “patient ID” is likely to be a single value, namely, an identifier that uniquely identifies a patient. The interest category “patient address”, on the other hand, might very comprise an enumeration of locations that could be of interest to the doctors in a medical facility. Thus, the “values” might consist of a list of city names.

According to an aspect of the present invention, the interest information 190 is specific to the data center. More particularly, the interest information is based on the interests of users of the data center. This allows each data center to indicate whether a particular subject file will be replicated to that data center. For example, a data center in a business enterprise that is responsible for accounting matters is likely to be interested in information relating to sales matters, purchases, and so on. Users at that data center would therefore specify interest categories relating to financial information. A system administrator can manage the interest information for her data center, receiving requests from users for new interest categories or updates to existing interest categories. Alternatively, administrative tools can be provided which allow the users to manage the interest information directly. For example, FIG. 5 shows that the data center associated with the interest information (more specifically, the users at the data center) have an interest in patients less than 20 years of age. There is also an interest in patients with cancer.

Referring to FIG. 6, the file profile information comprises for each file a “file ID,” a “patient ID,” “patient age,” “patient address,” “medical condition,” and so on. The tabular representation shown in the figure is provided for convenience. It can be understood that each row represents the file profile one file. Step 301 of FIG. 3 involves communicating one row of information, namely, the row corresponding to the subject file. Alternatively, step 301 can be a step in which the file profiles for two or more subject files are sent.

With reference to step 300 in FIG. 3, producing the file profile in this implementation of the embodiment of the present invention might involve searching or analyzing the subject file for key words such as “patient name,” “patient ID,” “medical condition,” and so one and extracting text from the file in the vicinity of any key words that are found. In an implementation where the file is a database record, the file may have some known data structure that can be exploited to facilitate producing the file profile. It is understood that the particular method or technique for extracting information from a file to produce a file profile is very much a function of the form of the interest information 190 and of the structure of the file being profiled.

To summarize FIGS. 5 and 6, in accordance with the present invention there is the idea of “interest information.” This interest information is associated with each data center and is representative of the collective interest of the users of a data center. In accordance with the present invention, there is also the idea of a file profile which represents the content of the subject file. The interest information and the file profile together are used to determine whether a data center will be the target for a file replication operation. A specific embodiment of this aspect of the present invention will now be discussed.

Referring then to FIG. 4, an explanation of the operation performed in step 311 of FIG. 3 will be made. It will be understood, of course, that FIG. 4 represents an illustrative implementation of this aspect of the present invention, and that any suitable computation or other method for determining an interest metric can be used. The operation shown in FIG. 4 is performed at each candidate data center. The calculation algorithm shown in FIG. 4 increments a counter for each category in the interest information 190 (FIG. 5) that is satisfied in the file profile of the subject file. Thus, in a step 400 a counter is initialized (e.g., set to zero). A loop 405 is executed for each received file profile item.

For each interest category in the interest table, a loop 410 is executed. The file profile is searched for an interest category, in a step 415. If the interest category is found in the file profile and the “value” in the file profile satisfies the corresponding condition given in the interest information, then the counter is incremented by one, steps 416, 417. This particular embodiment supposes that the interest categories are found in the file profile. In the case that the file profile does not contain the same interest categories, category matching can still be accomplished by using a taxonomy dictionary or the like. As an alternative to a unit increment, each interest category can be weighted so that the counter is incremented by a weighted increment value other than one. The counter (referred to as an “interest metric”) is then presented for further evaluation, step 420. In a specific implementation, step 420 might be a “return” from a function call, with the counter as a return value; which in this particular implementation indicates the matching degree of a file profile and an interest.

Returning to FIG. 3, upon computing the interest metric, it is communicated in a step 312 back to the replicator module 170 of the source file server. The replicator module collects interest metrics computed by each of the candidate target file servers, step 320. In a step 321, the replicator module then replicates the subject file(s) to those target file servers that satisfy a predetermined criterion. In one implementation, the subject file is replicated to the first N target file servers ranked according to their interest metrics. Thus, in this implementation, the interest metric and the decision making performed in step 321 collectively constitute the selection criteria for determining whether and where a subject file will replicated.

In another implementation of this embodiment of the present invention, the subject file can be replicated to each candidate target where its corresponding interest metric exceeds a predetermined value. In still another implementation of this embodiment of the present invention, each candidate target can return a YES/NO indication to the source file server instead of returning its computed interest metric. In this way each candidate target can decide for itself whether it wants a copy of the file. This allows each candidate target data center to use its own selection criteria to determine based on the file profile of a subject file whether the file will be replicated to that target data center.

To finish the discussion of FIG. 3, in a step 322 the subject files 323 are sent to each file server that has been determined to be a target for the replication. This may include updating the metadata 180 in the source file server to identify those file servers on which the subject file has been replicated. The receiving file server then interacts with its file I/O module 150 to effect a write operation of the received file (steps 330, 331), thus creating a replicated file. This may include updating its metadata 180 to identify the source file server. It is noted that it is possible for none of the candidate target file servers to have an interest in the subject file. If it is desirable that such a file nonetheless be replicated, the selection of a target file server(s) can be made using conventional selection techniques. In this way, the subject file is replicated somewhere in the data system even though none of the data centers expressed sufficient interest in the file.

Referring for a moment to FIG. 1, it can be appreciated that the present invention can incorporate redundancy to increase data access reliability in the source file server. For example, the source file server can be configured in a cluster structure so that if the source file server goes offline, another file server designated as the “recovery file server” can take over as the source file server. The metadata can be replicated to the recovery file server, and in the event that the source file server is determined to be offline (e.g., no acknowledgement is received from the source file server during a communication), a takeover procedure can be performed by the recovery file server to become the new source file server. For example, the takeover process might include communicating with each target site to replicate back all of the files that the original source file server used to have.

Instead of designating a recovery file server in advance, the determination can be made at the time the source file server is determined to have gone offline. According to this approach, each time a target file server receives a file (step 330), information that identifies other target file servers can be included. When a target file server determines that the source file server is offline (e.g., no acknowledgement from the source file server during a communication), the target file server can initiate communication among the other target file servers to decide which file server will be the new source site of the particular file. Also, if there is not enough replication (e.g. just one) for all sites, the new source site can perform a replication as shown in FIG. 3.

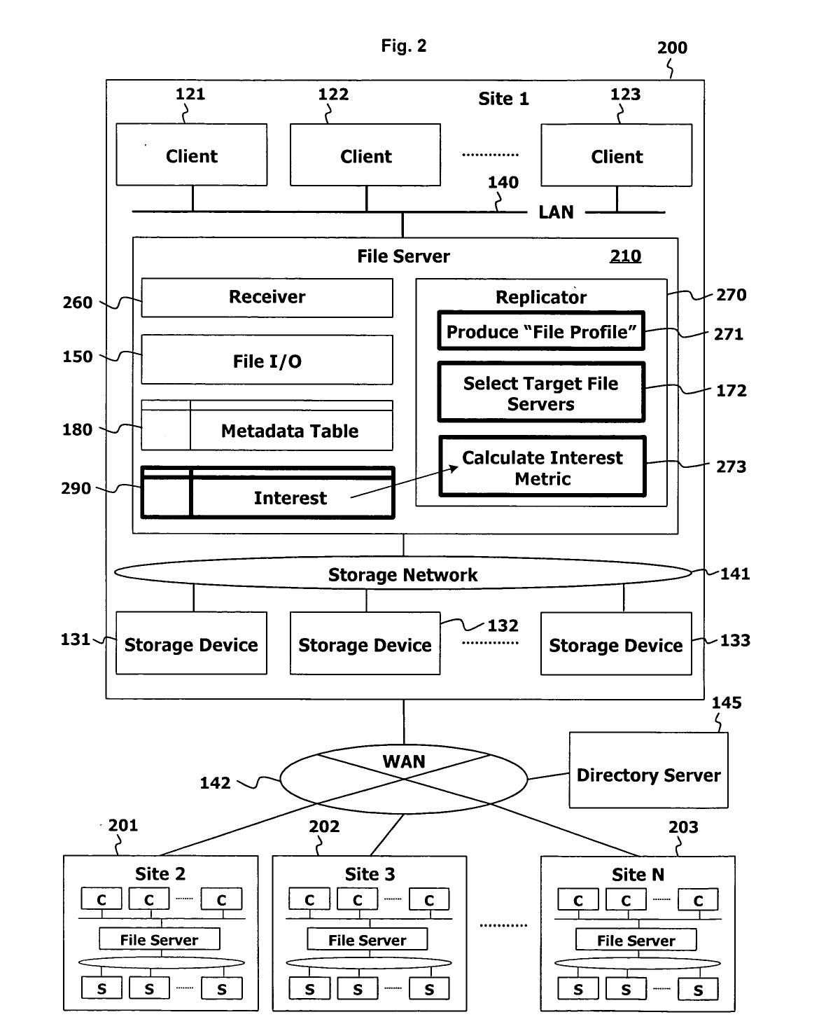

Referring now to FIG. 2, another embodiment of a data system according to the present invention is shown. Elements shown in FIG. 2 that are the same as those shown in FIG. 1 are identified by the same reference numeral. In this embodiment, a file server 210 comprises a replicator module 270 which includes a profile module 271 to produce file profiles, and a calculate interest metric module 273. The file server includes a receiver module 260 that simply operates to receive files to be stored in its data center.

Operation of the file server 210 is similar to the file server embodiment of FIG. 1. A subject file is profiled by the profile module 271 of the source file server that contains the subject file. In accordance with this embodiment of the invention, interest information 290 is provided to each file server in the system of data centers 200, 201, 202, 203. Thus, instead of communicating the resulting file profile to candidate target file servers, the file server (source file server) that contains the file to be replicated performs a computation of the interest metric using its associated interest information 290. The source file server can therefore produce an interest metric for each data center without having to communicate the file profile to each data center. The target file servers are selected as discussed above in step 321, and file replication is performed accordingly.

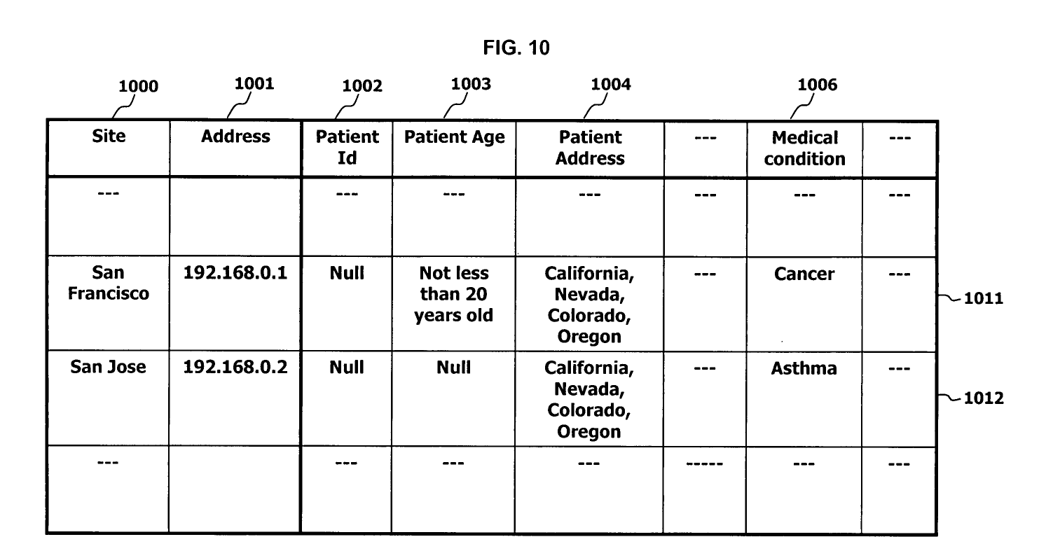

Refer for a moment to FIG. 10 which shows an illustrative example of the interest information 290. As can be seen, the interest categories shown in FIG. 5 are also shown in FIG. 10. However, in FIG. 10, the interest category values for each data center are provided, along with the data center's location information such as “site name” 1000 and “site address” 1001. The additional data center information allows the source file server to determine which data centers are sufficiently interested in the subject file without having to communicate with those data centers.

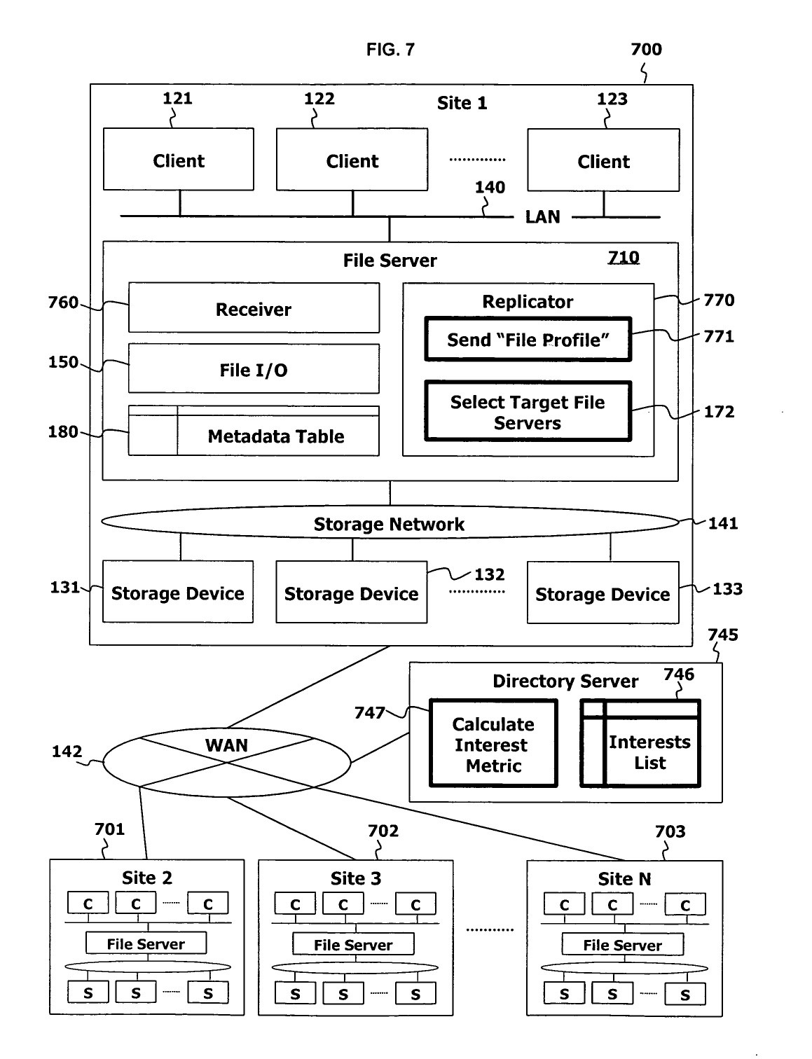

Referring now to FIG. 7, still another embodiment of a data system according to the present invention is described. Elements shown in FIG. 7 that are the same as those shown in FIG. 1 are identified with the same reference numerals. A file server 710 comprises a replicator module 770 and a receiver module 760. A directory server 745 is provided that comprises a calculate interest metric module 747 and interest information 746.

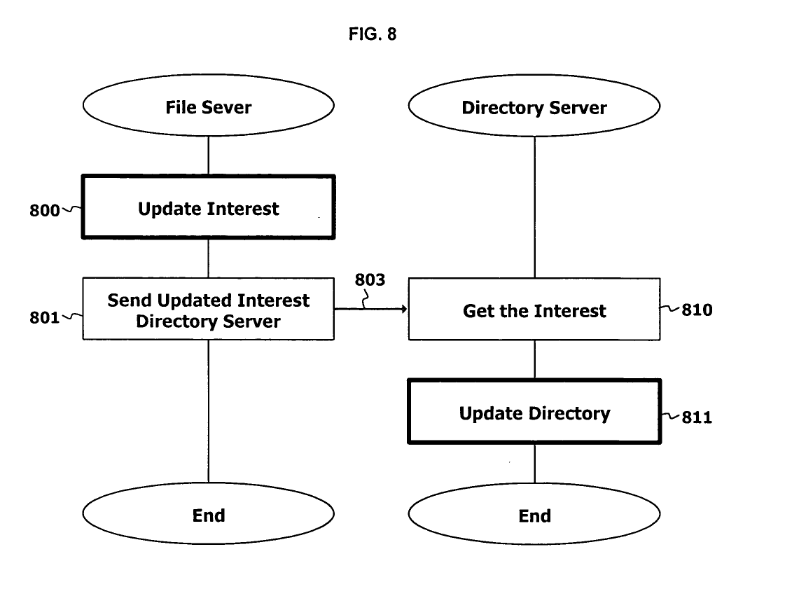

FIG. 8 shows typical operations that might be performed to update the interest information in the directory server 745. A file server 710 at a data center receives updated interest information from users, in a step 800. The update information 803 is communicated in a step 801 to the directory server. The directory server receives the information in a step 810 and in response, will update the interest information 746 accordingly in a step 811. Each data center 700, 701, 702, 703 in the system can communicate with the directory server in this manner to communicate its corresponding interest information to both create and maintain the interest information stored in the directory server.

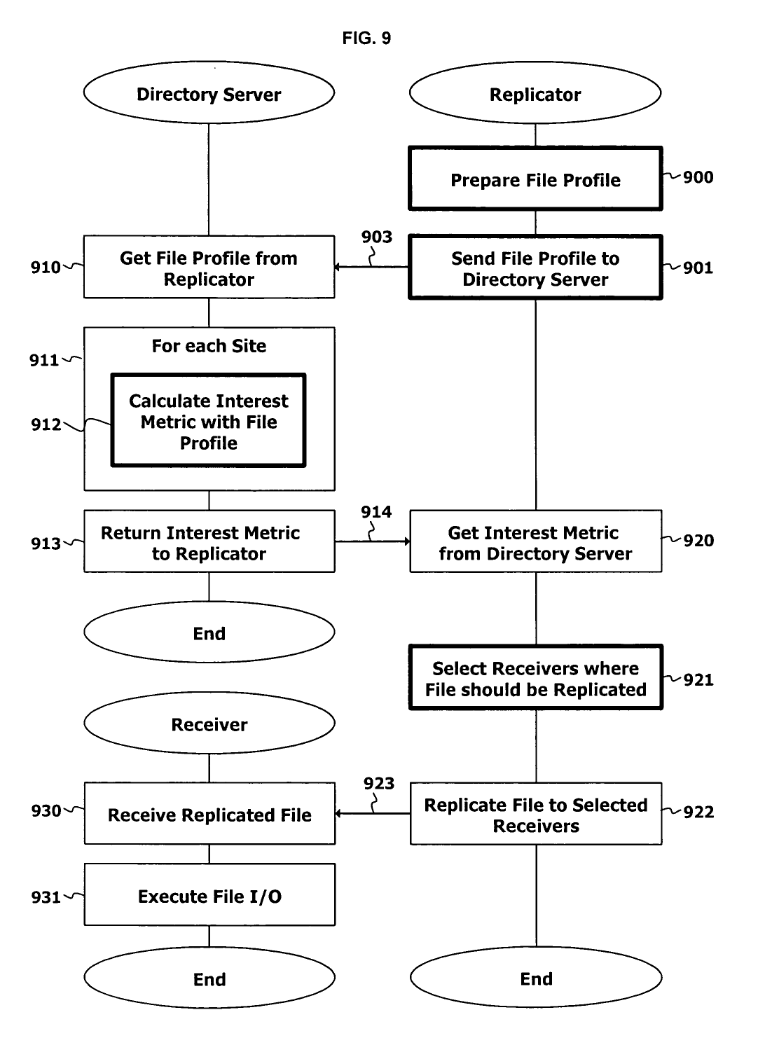

Operation of the file server 710 is outlined in the flowchart of FIG. 9. One or more subject files are profiled by a send profile module 771 in the replicator module 770 in a step 900. The file profile is then communicated to the directory server 745 in a step 901, and received in a step 910 by the directory server. The interest information 746 in the directory server comprises interest information specific to each data center so that an interest metric is determined for each candidate target file server (see FIG. 10). Thus, a loop 911 is executed for each data center that is identified in the interest information 746. The profile calculate interest metric module 747 performs the operations discussed above in connection with FIG. 4 for each data center, step 912. Interest metrics 914 are determined for each data center and returned in a step 913 to the replicator module of the source file server. Thus, in this particular embodiment, the directory server 745 operates as a calculation server to provide a service of calculating an interest metric for each data center. In another embodiment, the Select Target File Servers module 172 is also included in the Directory Server 745. In this particular embodiment, the Directory Server 745 operates as a selection server to provide a service of selecting data centers as targets for a file that is to be replicated.

The replicator module receives (step 920) the interest metrics and in a step 921 determines which data centers will be the target for replication of the subject file(s). As discussed in FIG. 3, the replicator module can choose the first N file servers ranked according to interest metric. Alternatively, each candidate target can be assessed independently of the other target file servers. For example, if the interest metric for a subject file exceeds a predetermined threshold value for a given data center, then the subject file is replicated to the file server in that data center.

In a step 922, files are replicated to the target file servers according to the determination made in step 921. The receiving module of the file server that receives a replicated file stores the file in its local storage subsystem (steps 930, 931) using the file I/O utilities at the receiving file server.

1. A method for distributing data among a plurality of data storage systems comprising:
obtaining and storing selection criteria;
producing profile information for a first data object that is stored in a first data storage system, said profile information comprising content-based information associated with said first data object; and
selectively copying said first data object to at least one second data storage system based on said selection criteria and on said profile information,
wherein said first data object is copied to said second data storage system depending on content-based information associated with said first data object.

2. The method of claim 1 wherein said first data storage system comprises a server component in communication with a data storage component.

3. The method of claim 2 wherein said second data storage system comprises a server component in communication with a data storage component.

4. The method of claim 1 wherein said selection criteria are stored in said second data storage system, said method further comprising:
communicating said profile information to said second data storage system;
producing a selection indication based on said selection criteria and on said profile information; and
selectively communicating said first data object to said second data storage system based on said selection indication.

5. The method of claim 4 wherein said profile information is communicated to a plurality of second data storage systems, said method further comprising:
receiving at said first data storage system a selection indication from each of said second data storage systems, wherein said selection indication is an interest metric;
producing an ordered set of said second data storage systems, ordered according to said interest metric; and
communicating said first data object to the first N of said second data storage systems.

6. The method of claim 4 wherein said profile information is communicated to a plurality of second data storage systems, said method further comprising:
receiving at said first data storage system a selection indication from each of said second data storage systems, wherein said selection indication is an interest metric;
communicating said first data object to a second data storage system if its interest metric exceeds a predetermined threshold.

7. The method of claim 4 wherein said profile information is communicated to a plurality of second data storage systems, said method further comprising receiving at said first data storage system a selection indication from each of said second data storage systems, wherein said selection indication indicates whether or not to communicate said first data object to said second data storage system.

8. The method of claim 4 wherein if said first data object is not copied to any other data storage system, then determining a replication site from among said other data storage systems independently of content of said first data object and copying said first data object to said replication site.

9. The method of claim 1 wherein said selection criteria are stored in said first data storage system, said method further comprising communicating said first data object to said second data storage system based on said profile information and on said selection criteria.

10. The method of claim 9 further comprising additional selection criteria for an additional second data storage system, said method further comprising communicating said first data object to said additional second data storage system based on said profile information and said additional selection criteria.

11. The method of claim 1 wherein said selection criteria are stored in a selection server system separate from said first data storage system and from said second data storage system, said method further comprising:
communicating said profile information to said selection server system;
producing in said selection server system a selection indication; and
communication said selection indication to said first data storage system,
wherein said first data object is selectively communicated to said second data storage system depending on said selection indication.

12. A distributed data storage system comprising a plurality of data servers, each data server comprising:
a client interface component configured for communication with one or more clients to exchange data;
a data storage interface component configured for data communication with data storage component; and
a data processing component configured to:
produce profile information associated with a first data object that is stored in said data storage component, said profile information comprising content-based information associated with content of said first data object;
initiate a comparison of selection criteria with said profile information, said selection criteria comprising criteria associated with at least a second data server, said selection criteria used to determine whether said first data object is copied to said at least a second data server; and
copy said first data object to said at least a second data server depending on an outcome of said comparison.

13. The data storage system of claim 12 wherein said data processing component is further configured to:
communicate said profile information to a plurality of candidate data servers;
receive a selection indication from each of said candidate data servers; and
copy said first data object to one or more of said candidate data servers based on selection indications received from said candidate data servers,
wherein a selection indication is produced by a candidate data server and is based on selection criteria stored in said candidate data server and on said profile information.

14. The data storage system of claim 13 wherein said selection indication is a metric that is based on selection criteria and on said profile information.

15. The data storage system of claim 13 wherein said selection indication is a binary indicator that indicates whether or not to copy said first data object to said second data server.

16. The data storage system of claim 15 wherein said data processing component is further configured to:
receive selection criteria from other data servers; and
based on said selection criteria and said profile information, selectively copy said first data object to one or more of said other data servers,
wherein said other data servers are selected based on selection criteria associated therewith and on said profile information.

17. The data storage system of claim 15 wherein said data processing component is further configured to:
communicate said profile information to a selection server system that is separate from said data servers;
receive selection information from said selection server system; and
based on said selection information, copy said first data object to one or more other data servers.

18. A method for distributing data among a plurality of data storage systems comprising:
obtaining and storing selection criteria in a first data storage system;
producing profile information for a first data object that is stored in said first data storage system, said profile information comprising content-based information associated with said first data object; and
selectively copying said first data object to at least one second data storage system based on said selection criteria and on said profile information,
wherein said first data object is copied to said second data storage system depending on content-based information associated with said first data object.

19. The method of claim 18 further comprising receiving, at said first data storage system, said selection criteria from one or more data storage systems other than said first data storage system.

20. A data system comprising:
a plurality of data centers; and
a plurality of client systems in data communication with said data centers,
each data center comprising:
a data storage component;
a file server component operable to exchange data between a client system and said data storage component;
a replicator component;
a receiver component; and
file selection criteria,
wherein said replicator component is operable to produce profile data for a data object that is to be replicated among one or more candidate target data centers and to receive a selection indication from each of said candidate target data centers, and to selectively communicate said data object to a candidate target data center based on its selection indication, said profile data representative of content of said data object,
wherein said receiver component is operable to receive profile data information from a source data center, said receiver component further operable to communicate a selection indication to said source data center based on said file selection criteria and on said profile data.

21. The system of claim 20 wherein said selection indication is an interest metric that is determined based on said file selection criteria and on said profile data, wherein said replicator component is further operable to communicate said data object to a candidate data center based on its interest metric, wherein said candidate target data centers are ordered to produce an ordered set based on their corresponding interest metrics and said replicator component is further operable to communicate said data object to the first N target data centers selected from said ordered set.

22. The system of claim 20 wherein said selection indication is an interest metric that is determined based on said file selection criteria and on said profile data, wherein said replicator component is further operable to communicate said data object to a candidate data center based on its interest metric, wherein said replicator component communicates said data object to a candidate target center if its interest metric exceeds a predetermined threshold.

23. The system of claim 20 wherein said selection indication is an indication of whether or not to communicate said data object to said candidate target data center.

24. A data system comprising:
a plurality of data centers; and
a plurality of client systems in data communication with said data centers,
each data center comprising:
a data storage component;
a file server component operable to exchange data between a client system and said data storage component;
a replicator component; and
a collection of selection criteria comprising selection criteria provided from other data centers,
wherein said replicator component is operable to produce profile data for a data object that is to be replicated among one or more candidate target data centers and to selectively communicate said data object to said candidate target data centers based on said profile data and selection criteria corresponding to each of said candidate target data centers, said profile data representative of content of said data object.

25. The system of claim 24 wherein said replicator module is operable to produce based on said collection selection criteria and on said profile data a plurality of interest metrics, each interest metric corresponding a data center, wherein said candidate target data centers are ordered to produce an ordered set based on their corresponding interest metrics, wherein said replicator component is further operable to communicate said data object to the first N target data centers selected from said ordered set.

26. The system of claim 24 wherein said replicator module is operable to produce based on said collection selection criteria and on said profile data a plurality of interest metrics, each interest metric corresponding a data center, wherein said replicator component communicates said data object to a candidate target center if its interest metric exceeds a predetermined threshold.

27. A data system comprising:
a plurality of data centers, each data center having associated therewith a plurality of client systems; and
a selection server system in data communication with said data centers,
each data center comprising:
a data storage component;
a file server component operable to exchange data between a client system and said data storage component; and
a replicator component,
wherein said replicator component is operable to produce profile data for a data object that is to be replicated among one or more candidate target data centers, to communicate said profile data to said selection server system, and to receive from said selection server system a plurality selection indicators, said profile data representative of content of said data object,
wherein said data object is selectively communicated to said candidate target data centers based on said selection indicators,
said selection server system comprising a collection of selection criteria comprising selection criteria provided from other data centers, and operable to produce said selection indicators based on said profile data and on said collection of selection criteria.

28. The data system of claim 27 wherein said selection server system is a directory server.
